(19) United States
(12) Patent Application Publication
(10) Pub. No.: US 2011/0251330 A1
(43) Pub. Date: Oct. 13, 2011

(54) Nylon-Based Alloy Resin Compostion and Light Emitting Diode (LED) Reflector Using the Same

(75) Inventors: Duk-Hee KIM, Uiwang-si (KR); Chang-Min HONG, Uiwang-si (KR)

(73) Assignee: CHEIL INDUSTRIES INC., Gumi-si (KR)

(21) Appl. No.: 13/165,875

(22) Filed: Jun. 22, 2011

Related U.S. Application Data
(63) Continuation-in-part of application No. PCT/KR2009/007170, filed on Dec. 2, 2009.

(30) Foreign Application Priority Data
Dec. 24, 2008 (KR) 10-2008-0133684

(51) Int. Cl. C08L 77/06; C08K 3/22; C08L 25/06; C08K 7/14

(52) U.S. Cl. 524/494; 524/514; 524/497

(57) ABSTRACT

A nylon-based alloy resin composition including (A) a modified nylon-based thermoplastic resin including a benzene ring in a main chain, (B) a styrene-based thermoplastic resin having a syndiotactic structure, and (C) an inorganic filler and a light emitting diode (LED) reflector using the same is provided.

### CROSS-REFERENCE TO RELATED APPLICATIONS

This application is a continuation-in-part of International Application No. PCT/KR2009/007170, filed on Dec. 2, 2009, pending, which designates the U.S., published as WO 2010/074417, and is incorporated herein by reference in its entirety. This application also claims priority to and the benefit of Korean Patent Application No. 10-2008-0133684 filed in the Korean Intellectual Property Office on Dec. 24, 2008, the entire disclosure of which is also incorporated herein by reference.

### FIELD OF THE INVENTION

The present invention relates to a nylon-based alloy resin composition and an LED (light emitting diode) reflector including the same.

### BACKGROUND

Nylon has a long history of 40 years as an engineering plastic. There are many kinds of nylon, such as nylon 6, nylon 66, nylon 610, nylon 612, nylon 11, nylon 12, copolymers thereof, and blends thereof, among others. Nylons have useful features for various different applications, and there continues to be a large demand for the same.

Adding an inorganic reinforcing material such as glass fiber can improve the mechanical strength and heat resistance of a nylon-based resin. Fiber filled nylon resins can be used in various products such as automobile interior and/or exterior materials.

Nylon-based resins can also be used for parts of light emitting diodes (LEDs) such as reflectors, reflector cups, scramblers, housings, and the like. Light emitting diodes have replaced many conventional light sources and are the focus of increased attention because of their excellent energy efficiency and life-span. One example of a nylon-based resin used in LED applications is a modified nylon-based resin including a benzene ring in the main chain of the nylon resin and reinforced with glass fiber.

Nylon resins can be useful in LED applications because the resin can endure high temperatures during LED manufacturing processes and can have a high initial whiteness and thus excellent reflection rate. In addition, nylon resins are not conductive and can minimize whiteness deterioration due to yellowing resulting from continuous exposure to a light source. However, because of its molecular structure, the nylon-based resin can exhibit a high moisture absorption rate, and thus poor dimensional stability and warpage characteristics. In addition, since it becomes opaque due to the crystal structure, it may not provide a product with a bright color.

Various additives can be added to nylon resin to overcome these problems. There is still a need, however, for an improved nylon resin that is practical for commercial use. Korean Patent Laid-Open Publication No. 2006-129328 discloses a nylon resin stated to have improved warpage characteristics by adding a plate glass fiber to a highly thermal resistant modified nylon.

Furthermore, there have been many attempts to increase whiteness, for example by adding titanium dioxide to a nylon resin, so that the resulting nylon resin can be used for parts of a light emitting diode. As another example, Japanese Patent Laid-Open Publication No. 2000-204244 and U.S. Pat. No. 7,009,029 disclose a method of improving whiteness by using PA9T, which is a nylon including an aliphatic diamine with nine carbon atoms. However, the method did not improve dimensional stability and warpage characteristics of the nylon.

U.S. Patent Laid-Open Publication Nos. 2006-0148962 and 2006-0293427 disclose a method of adding a thermally conductive material such as carbon black in order to quickly disperse heat and thus prevent the yellowing phenomenon. The method, however, can decrease whiteness due to the presence of the thermally conductive material. Also, the resin may not have improved dimensional stability and warpage characteristics.

U.S. Pat. Nos. 6,093,768 and 6,043,307 disclose a method of increasing impact strength by adding a rubber. The resin, however, does not have desired heat resistance, and thus may not endure high temperatures during the manufacturing process.

### SUMMARY

An exemplary embodiment of the present invention provides a nylon-based alloy resin composition that can have excellent heat resistance, dimensional stability, and/or warpage characteristics and can have a high white color.

Another embodiment of the present invention provides a LED component, such as a LED reflector, fabricated using the nylon-based alloy resin composition.

The nylon-based alloy resin composition includes: (A) 20 to 70 wt % of a modified nylon-based thermoplastic resin including a benzene ring in the main chain; (B) 10 to 70 wt % of a syndiotactic styrene-based thermoplastic resin; and (C) 10 to 60 wt % of an inorganic filler.

The modified nylon-based thermoplastic resin may be prepared by condensation-polymerizing a dicarboxylic acid monomer including 10 to 100 mol % of an aromatic dicarboxylic acid with an aliphatic or alicyclic diamine.

Examples of the modified nylon-based thermoplastic resin may include without limitation nylon 6T, nylon 9T, nylon 10T, nylon 11T, nylon 12T, nylon 6T/66, nylon 10T/1012, nylon 61/66, nylon 6T/61/66, and the like, and combinations thereof.

The styrene-based thermoplastic resin may be polystyrene and have a weight average molecular weight ranging from 10,000 to 5,000,000 g/mol and a melting point ranging from 200 to 320° C.

The nylon-based alloy resin composition may include the modified nylon-based thermoplastic resin and the styrene-based thermoplastic resin in a weight ratio ranging from 0.3:1 to 7:1.

The inorganic filler may be a fiber-type filler including a glass fiber, a carbon fiber, an alumina fiber, an aramid fiber, a carbonized silicon fiber, or a combination thereof; a grain- or powder-type filler including talc, carbon black, titanium dioxide, barium carbonate, magnesium carbonate, or a combination thereof; or a combination thereof. In exemplary embodiments, the inorganic filler may be prepared by mixing 10 to 90 wt % of the glass fiber and 10 to 90 wt % of the titanium dioxide. The glass fiber may have a cross-section aspect ratio ranging from 1.5 to 8. The titanium dioxide may have a particle size ranging from 0.1 to 0.4 μm. The inorganic filler may have a moisture absorption rate of 0.05% or less.

The nylon-based alloy resin composition may further include an additive such as an antioxidant, a heat stabilizer, a light stabilizer, a fluid developing agent, a lubricant, a biocide, a release agent, a nucleating agent, a fluorescent whitening agent, or a combination thereof.

The nylon-based alloy resin composition may have viscosity ranging from 100 to 500 Pa·s at a shear rate ranging from 60 to 100 s⁻¹.

Yet another embodiment provides an LED component, such as a LED reflector, prepared using the nylon-based alloy resin composition. Hereinafter, further aspects of the present invention will be described in detail.

### BRIEF DESCRIPTION OF THE DRAWINGS

FIG. 1 schematically illustrates the cross-sectional aspect ratio of a glass fiber according to one embodiment.

FIG. 2 is a graph showing viscosity results of the nylon-based alloy resin compositions according to Examples 2 to 6 and Comparative Examples 1 and 2.

### DETAILED DESCRIPTION

The present invention will be described more fully hereinafter in the following detailed description of the invention, in which some but not all embodiments of the invention are described. Indeed, this invention may be embodied in many different forms and should not be construed as limited to the embodiments set forth herein; rather, these embodiments are provided so that this disclosure will satisfy applicable legal requirements.

The nylon-based alloy resin composition according to one embodiment includes (A) 20 to 70 wt % of a modified nylon-based thermoplastic resin including a benzene ring in the main chain, (B) 10 to 70 wt % of a syndiotactic styrene-based thermoplastic resin, and (C) 10 to 60 wt % of an inorganic filler.

Exemplary components included in the nylon-based alloy resin composition according to embodiments will hereinafter be described in detail.

(A) Modified Nylon-Based Thermoplastic Resin

The modified nylon-based thermoplastic resin includes a benzene ring in the main chain, and may be prepared by condensation-polymerizing a dicarboxylic acid monomer including 10 to 100 mol % of an aromatic dicarboxylic acid with an aliphatic or alicyclic diamine monomer.

In exemplary embodiments, the aromatic dicarboxylic acid may be terephthalic acid (TPA) represented by the following Chemical Formula 1, or isophthalic acid (IPA) represented by the following Chemical Formula 2.

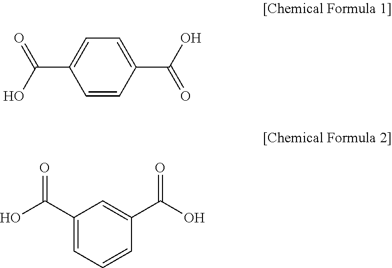

The aliphatic or alicyclic diamine may be represented by the formula NRR′ wherein R and R′ are each independently hydrogen or substituted or unsubstituted C4 to C20 alkyl.

Examples of the modified nylon-based thermoplastic resin may include a product prepared by condensation-polymerizing hexamethylene diamine and terephthalic acid. The product may be simply called nylon 6T, and is represented by the following Chemical Formula 3.

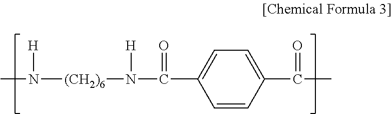

According to one embodiment, the modified nylon-based thermoplastic resin may further include an aliphatic polyamide which is different from the modified nylon-based thermoplastic resin such as nylon 6T. Examples of the aliphatic polyamide include without limitation nylon 6, nylon 66, and the like, and combinations thereof.

When present, the mixture of the modified nylon-based thermoplastic resin and the aliphatic polyamide may include the modified nylon-based thermoplastic resin in an amount of 50 to 95 wt % and the aliphatic polyamide in an amount of 5 to 50 wt %.

In some embodiments, the mixture of the modified nylon-based thermoplastic resin and the aliphatic polyamide may include the modified nylon-based thermoplastic resin in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt %. Further, according to some embodiments of the present invention, the amount of modified nylon-based thermoplastic resin can be in a range from about any of the foregoing amounts to about any other of the foregoing amounts.

In some embodiments, the mixture of the modified nylon-based thermoplastic resin and the aliphatic polyamide may include the aliphatic polyamide in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments of the present invention, the amount of the aliphatic polyamide can be in a range from about any of the foregoing amounts to about any other of the foregoing amounts.

When the modified nylon-based thermoplastic resin and the aliphatic polyamide are mixed in amounts within this ratio, they may improve fluidity and thus bring about easy molding and lower process temperatures.

Examples of the modified nylon-based thermoplastic resin may include without limitation nylon 6T, nylon 9T, nylon 10T, nylon 11T, nylon 12T, nylon 6T/66, nylon 10T/1012, nylon 61/66, nylon 6T/61/66, and the like, and combinations thereof.

The nylon-based alloy resin composition of the invention may include the modified nylon-based thermoplastic resin in an amount of 20 to 70 wt %, for example 20 to 40 wt %, based on the total weight of the nylon-based alloy resin composition. In some embodiments, the nylon-based alloy resin composition may include the modified nylon-based thermoplastic resin in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the modified nylon-based thermoplastic resin can be in a range from about any of the foregoing amounts to about any other of the foregoing amounts.

When the nylon-based alloy resin composition includes the modified nylon-based thermoplastic resin in an amount within these ranges, it may bring about excellent heat resistance and whiteness.

(B) Styrene-Based Thermoplastic Resin

The styrene-based thermoplastic resin is a styrene-based thermoplastic resin in which the polymer molecular chain has a syndiotactic structure.

The syndiotactic structure of a styrene-based resin indicates a three-dimensional chemical structure in which substituted or unsubstituted phenyl groups are alternately bound at opposite side chains to the main chain including carbon-carbon bonds (stated differently, substituted or unsubstituted phenyl groups are attached to alternating sides of the polymer backbone chain). Its tacticity can be measured with a nuclear magnetic resonance method (¹³C-NMR) using carbon isotopes. As used herein, the term “substituted” refers to being substituted by a C1 to C30 alkyl group or a C2 to C30 alkenyl group.

Examples of the styrene-based thermoplastic resin may include polystyrene with a syndiotactic structure and the like.

The styrene-based thermoplastic resin may have no particular limit in molecular weight, but may have a weight average molecular weight of 10,000 g/mol or more. In exemplary embodiments, the styrene-based thermoplastic resin may have a weight average molecular weight ranging from 10,000 to 5,000,000 g/mol, in another embodiment a weight average molecular weight ranging from 50,000 to 5,000,000 g/mol, and in still another embodiment a weight average molecular weight ranging from 100,000 to 3,000,000 g/mol. When the styrene-based thermoplastic resin has a weight average molecular weight within these ranges, it can maintain an excellent balance between heat resistance and mechanical properties and improve workability, since it may exhibit no or minimal phase separation when it is alloyed with a modified nylon-based thermoplastic resin.

The styrene-based thermoplastic resin may have a melting point ranging from 200 to 320° C. When the styrene-based thermoplastic resin has a melting point within this range, it may provide excellent heat resistance.

The nylon-based alloy resin composition of the invention may include the styrene-based thermoplastic resin in an amount of 10 to 70 wt %, for example, 10 to 50 wt %, and as another example 10 to 40 wt %, based on the total weight of the nylon-based alloy resin composition. In some embodiments, the nylon-based alloy resin composition may include the styrene-based thermoplastic resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt %. Further, according to some embodiments of the present invention, the amount of the styrene-based thermoplastic resin can be in a range from about any of the foregoing amounts to about any other of the foregoing amounts.

When the styrene-based thermoplastic resin is included in an amount within these ranges, it may provide excellent heat resistance, workability, and warpage characteristics. In addition, including the styrene-based thermoplastic resin in an amount within these ranges can lower the viscosity of the nylon-based alloy resin composition and thus improve extrusion fluidity.

According to one embodiment, the modified nylon-based thermoplastic resin and the styrene-based thermoplastic resin can be present in a weight ratio of ranging from 0.3:1 to 7:1, for example 0.5:1 to 4:1. When the modified nylon-based thermoplastic resin and the styrene-based thermoplastic resin are used in an amount within these weight ratio ranges, they may be used for high resistance applications without using a compatibilizer. The two resins can be used in electronics requiring high resistance such as an LED reflector and the like, since the two resins have minimal or no phase separation and can improve heat resistance.

(C) Inorganic Filler

Since the modified nylon-based thermoplastic resin and the styrene-based thermoplastic resin in general have minimal or no compatibility with each other, a compatibilizer can be used with the resins to prevent impact strength deterioration. However, since highly heat-resistant electronics such as an LED reflector and the like are small, for example 1 mm or less, they do not need to be reinforced in terms of impact using a compatibilizer. In addition, when the compatibilizer is used, it may deteriorate heat resistance of the two resins, aggravating the yellowing phenomenon and bringing about low whiteness. Accordingly, the present invention provides the use of an inorganic filler to accomplish excellent heat resistance, warpage, and high whiteness characteristics rather than separately using a compatibilizer as aforementioned.

The inorganic filler may be a fiber type, a granular or powder type, or a combination thereof. In exemplary embodiments, the inorganic filler may be a mixture of the fiber type and the granular or powder type.

Examples of the fiber type may include without limitation glass fiber, carbon fiber, alumina fiber, aramid fiber, carbonized silicon fiber, and the like, and combinations thereof. Examples of the granular or powder type may include without limitation talc, carbon black, titanium dioxide, barium carbonate, magnesium carbonate, and the like, and combinations thereof. In exemplary embodiments, the inorganic filler may include a mixture of glass fiber and titanium dioxide.

When the inorganic filler includes a fiber type and a granular or powder type mixed together, the fiber-type inorganic filler may be included in an amount of 10 to 90 wt %, for example 25 to 75 wt %, and the granular or powder-type inorganic filler may be included in an amount of 10 to 90 wt %, for example 25 to 75 wt %.

In some embodiments, the mixture of the fiber-type inorganic filler and the granular or powder-type inorganic filler may include the fiber-type inorganic filler in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the fiber-type inorganic filler can be in a range from about any of the foregoing amounts to about any other of the foregoing amounts.

In some embodiments, the mixture of the fiber-type inorganic filler and the granular or powder-type inorganic filler may include the granular or powder-type inorganic filler in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of the granular or powder-type inorganic filler can be in a range from about any of the foregoing amounts to about any other of the foregoing amounts.

When a mixture of the fiber-type inorganic filler and the granular or powder-type inorganic filler is used in amounts within the above ranges, the mixture of filler can provide excellent warpage characteristic, yellowing resistance, and/or high whiteness.

The titanium dioxide may include both rutile and anatase depending on the crystal structure. In exemplary embodiments, the rutile structure may be used since titanium dioxide with the rutile structure has a high refractive index and good concealment, and is also stable with a thermoplastic resin.

The titanium dioxide may have a particle size ranging from 0.1 to 0.4 μm, for example 0.1 to 0.2 μm, and as another example 0.14 to 0.17 μm, where the blue wavelength has a maximum dispersion. When the titanium dioxide has a particle size within these ranges, it can provide excellent whiteness.

The glass fiber may be 0.1 to 13 mm long and have a diameter ranging from 5 to 30 μm. In addition, the glass fiber may be a specially-prepared plate.

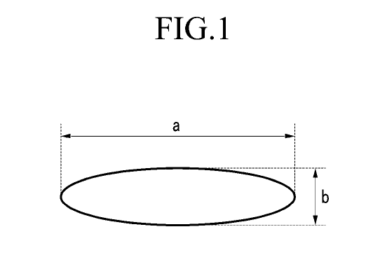

The glass fiber may be a common glass fiber with a cross-section aspect ratio of 1. Alternatively, the glass fiber may have a a cross-sectional aspect ratio of 1.5 or more, for example, a cross-sectional aspect ratio ranging from 1.5 to 8, and as another example a cross-sectional aspect ratio ranging from 2 to 8. As used herein, the cross-sectional aspect ratio, as shown in FIG. 1, is defined as a ratio of the longest diameter (a) to the shortest diameter (b). When the glass fiber has a cross-sectional aspect ratio of 1.5 or more, it may provide excellent warpage characteristics.

The glass fiber may be coated on the surface with at least one surface improving agent to increase its surface attachment to the modified nylon-based thermoplastic resin. Examples of the surface improving agent include without limitation urethane resins, epoxy resins, silicone resins, and the like, and combinations thereof. Surface improving agents are known in the art and can be used in conventional amounts.

According to one embodiment, an inorganic filler having a moisture absorption rate of 0.05% or less is used. While the inorganic filler may not bring about transformation due to the low moisture absorption rate it can have excellent dimensional stability, thereby improving warpage characteristics.

The nylon-based alloy resin composition of the invention may include the inorganic filler in an amount of 10 to 60 wt %, for example 20 to 55 wt %, and as another example 30 to 50 wt %, based on the total weight of the nylon-based alloy resin composition. In some embodiments, the nylon-based alloy resin composition of the invention may include the inorganic filler in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt %. Further, according to some embodiments of the present invention, the amount of the inorganic filler can be in a range from about any of the foregoing amounts to about any other of the foregoing amounts.

When an inorganic filler is included in an amount within these ranges, it may provide both excellent warpage characteristics and excellent yellowing resistance.

According to one embodiment, the nylon-based alloy resin composition of the invention may further include one or more additives such as but not limited to an antioxidant, a heat stabilizer, a light stabilizer, a fluid developing agent, a lubricant, a biocide, a release agent, a nucleating agent, a fluorescent whitening agent, or a combination thereof, in conventional amounts known on the art, as long as the additive(s) do not harm the basic properties of the resin composition. The fluorescent whitening agent may have a fusion temperature (Tₘ) of 350° C. or higher.

According to one embodiment, a nylon-based alloy resin composition may have viscosity ranging from 100 to 500 Pa·s at 320° C. at a shear rate ranging from 60 to 100 s⁻¹ using a capillary rheometer. The nylon-based alloy resin composition having low viscosity as aforementioned may improve extrusion fluidity.

The nylon-based alloy resin composition may be prepared using conventional methods known in the art for preparing a resin composition. For example, each component according to the present invention can be simultaneously mixed, optionally with one or more other additives, and then melt-extruded in a twin-screw extruder, preparing a pellet.

The nylon-based alloy resin composition according to one embodiment may be used in the production of a molded product requiring heat resistance, dimensional stability, and warpage characteristics, for example, auto exterior/interior materials as well as high heat-resistant electronics such as LED parts (reflectors, scramblers, and the like).

The following examples illustrate the present invention in more detail. However, it is understood that the present invention is not limited by these examples.

### Example

The components used for preparing a nylon-based alloy resin composition according to one embodiment are as follows.

(A) Modified Nylon-Based Thermoplastic Resin

A highly heat-resistant modified nylon having a benzene ring in the main chain (polyphthalamide; DuPont Co. HTN-501) is used. The HTN-501 consists of PA6T/61166.

(B) Styrene-Based Thermoplastic Resin

Zarex 130ZC (Idemitsu Co., Ltd.) is used.

(C) Inorganic Filler

(C-1) Tiona 188 (Millennium Chemicals Inc.) as a titanium dioxide is used.

(C-2) P952 (Vetrotex Co., Ltd.) is used as a round glass fiber with a cross-section aspect ratio of 1, a length of 3 mm, and a diameter of 10 μm.

(C-3) CSG 3PA-820 (Japanese Nitto Boseki Co. Ltd.) is used as a glass fiber with a cross-sectional aspect ratio of 4 (a horizontal diameter of 28 μm and a vertical diameter of 7 μm in the cross-section).

### Examples 1 to 6 and Comparative Examples 1 to 3

The aforementioned components are used according to the amounts set forth in the following Table 1 to prepare nylon-based alloy resin compositions for Examples 1 to 6 and Comparative Examples 1 to 3.

Each component is mixed in a conventional mixer according to the amounts set forth in the following Table 1. The mixture is placed in a twin-screw extruder with L/D=36 and ¢=45 mm. Then, the resulting mixture is prepared into a pellet-type resin composition using the extruder, preparing a specimen at a temperature of 330° C. with a 10 oz injection molder to evaluate the properties.

### Experimental Example 1

### Thermal Distortion Temperature, Warpage, and Heat-Resistant Color Change Measurements

The pellets according to Examples 1 to 6 and Comparative Examples 1 to 3 are dried at 100° C. for more than 3 hours and prepared into specimens using a 10 oz injection molding machine at a forming temperature ranging from 270 to 340° C. and a molding temperature ranging from 90 to 130° C. The properties of the specimens are measured using the following methods. The results are provided in the following Table 1.

(1) Thermal distortion temperature: according to ASTM D-648, a ¼-inch (6.4 mm) thick specimen is put in oil that is increased in temperature at a speed of 120° C./hr and subjected to a pressure of 1.86 MPa. Then, the temperature at which the specimen bends up to 0.254 mm is determined.

(2) Warpage characteristic: a 6″×6″ 1/16″-thick film gate mold is maintained at 80° C. and extruded in a 10 oz extruder with power of 95%, allowed to stand in a constant temperature/humidity room temperature of 23° C. and 50% humidity for 24 hours with no external pressure, and the warpage thereof is measured. The warpage is measured by closing three vertexes of the quadrangle specimen up to the bottom, and then measuring the other highly-raised vertex.

(3) Heat-resistant color change: initial color and yellowing of the specimens are measured after placing the specimens in an oven at 180° C. for 18 hours by measuring L*(brightness), b″ (blue-yellow index), and reflectance using a spectrophotometer (CM-3600d, KONICA MINOLTA). As used herein, L* has a value ranging from 1 to 100, and the higher values are better. As for b*, a lower value indicates blue-based colors, and a higher value indicates yellow-based colors. In addition, a highly white color is indicated by high L* and low b*.

TABLE 1

| | | | | | | | | | Comparative | | |
|---|---|---|---|---|---|---|---|---|---|---|---|
| | | | Example | | | | | | Example | | |
| | | | 1 | 2 | 3 | 4 | 5 | 6 | 1 | 2 | 3 |
| (A) Modified nylon-based | | | 40 | 40 | 20 | 30 | 30 | 40 | 60 | 70 | — |
| thermoplastic resin (wt %) | | | | | | | | | | | |
| (B) Styrene-based | | | 20 | 20 | 40 | 10 | 10 | 20 | — | — | 60 |
| thermoplastic resin (wt %) | | | | | | | | | | | |
| (C) | (C-1) Titanium | | 20 | 20 | 20 | 20 | 40 | 20 | 20 | 30 | 20 |
| Inorganic | dioxide (wt %) | | | | | | | | | | |
| filler | (C-2) Glass fiber | | 10 | — | — | — | — | 20 | — | — | — |
| | having a cross- | | | | | | | | | | |
| | section aspect | | | | | | | | | | |
| | ratio of 1 (wt %) | | | | | | | | | | |
| | (C-3) Glass fiber | | 10 | 20 | 20 | 40 | 20 | — | 20 | — | 20 |
| | having a cross- | | | | | | | | | | |
| | section aspect | | | | | | | | | | |
| | ratio of 4 (wt %) | | | | | | | | | | |
| (1) Thermal distortion | | | 270 | 270 | 260 | 270 | 260 | 270 | 270 | 140 | 240 |
| temperature (° C.) | | | | | | | | | | | |
| (2) Warpage (mm) | | | 1.6 | 0.9 | 0.7 | 0.5 | 0.7 | 2.5 | 4.8 | 6.5 | 0.7 |
| (3) Heat- | L* | Initial | 97 | 97 | 95 | 95 | 96 | 97 | 97 | 97 | 98 |
| resistant | | After | 93 | 94 | 94 | 93 | 94 | 94 | 95 | 90 | 96 |
| color | | staying | | | | | | | | | |
| change | | in oven | | | | | | | | | |
| (180° C./ | b* | Initial | 2.0 | 2.0 | 2.0 | 2.5 | 2.0 | 2.0 | 2.0 | 1.5 | 0.5 |
| 18 hr) | | After | 5.5 | 5.5 | 5.5 | 5.3 | 5.5 | 5.6 | 4.5 | 8.0 | 3.5 |
| | | staying | | | | | | | | | |
| | | in oven | | | | | | | | | |

Referring to Table 1, Examples 1 to 6 including a modified nylon-based thermoplastic resin, a styrene-based thermoplastic resin with a syndiotactic structure, and an inorganic filler within the aforementioned range all have better heat resistance, warpage, and heat-resistant color change characteristics than Comparative Examples 1 and 2 including no styrene-based thermoplastic resin and Comparative Example 3 including no modified nylon-based thermoplastic resin.

In addition, Examples 2 to 5 including titanium dioxide as an inorganic filler and a glass fiber having a cross-sectional aspect ratio of 1.5 or more have an excellent warpage characteristic compared with Example 1 including titanium dioxide and having a cross-sectional aspect ratio of 1.5 or less.

### Experimental Example 2

### Extrusion Fluidity Measurement

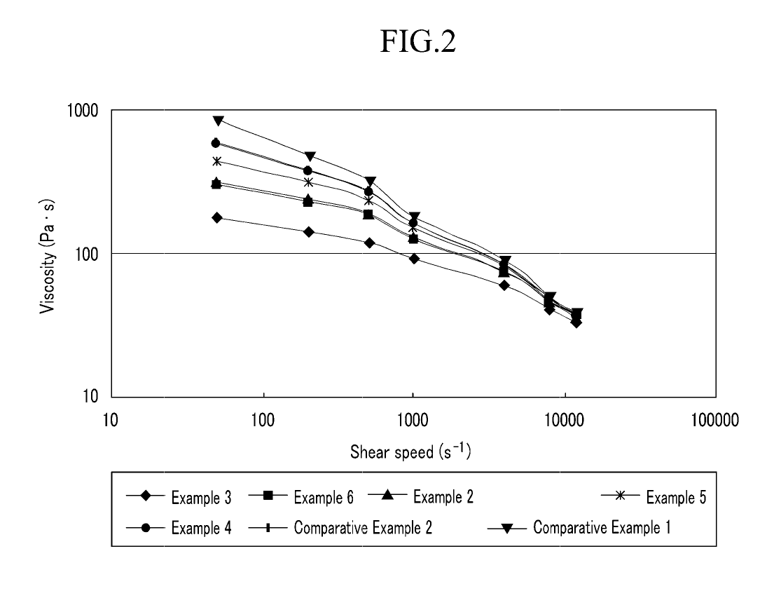

Extrusion fluidity of the specimens of Examples 2 to 6 and Comparative Examples 1 and 2 is measured using the following method. The results are provided in FIG. 2.

The extrusion fluidity is evaluated by measuring resin viscosity at 320° C. at a high shear rate at which fluidity of the specimen can be copied when actually extruded using a Gottfert's capillary rheometer (RHEO-TESTER 2000).

FIG. 2 is a graph showing viscosity results of the nylon-based alloy resin compositions according to Examples 2 to 6 and Comparative Examples 1 and 2. In FIG. 2, the X-axis indicates shear speed, while the Y-axis indicates viscosity.

As shown in FIG. 2, Examples 2 to 6 including a styrene-based thermoplastic resin having a syndiotactic structure have lower viscosity than Comparative Examples 1 and 2 including no styrene-based thermoplastic resin, and thus have excellent extrusion fluidity. In particular, Example 3 including the largest amount of styrene-based thermoplastic resin having a syndiotactic structure has lower viscosity than Examples 2, 6, 4, and 5 sequentially including less styrene-based thermoplastic resin. Accordingly, the more styrene-based thermoplastic resin having a syndiotactic structure is included, the better extrusion fluidity it may bring about due to low viscosity.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A nylon-based alloy resin composition comprising:
(A) 20 to 70 wt % of a modified nylon-based thermoplastic resin including a benzene ring in its main chain;
(B) 10 to 70 wt % of a syndiotactic styrene-based thermoplastic resin; and
(C) 10 to 60 wt % of an inorganic filler.

2. The nylon-based alloy resin composition of claim 1, wherein the modified nylon-based thermoplastic resin is prepared by condensation-polymerizing a dicarboxylic acid monomer including an aromatic dicarboxylic acid in an amount ranging from 10 to 100 mol % with an aliphatic or alicyclic diamine monomer.

3. The nylon-based alloy resin composition of claim 1, wherein the modified nylon-based thermoplastic resin comprises nylon 6T, nylon 9T, nylon 10T, nylon 11T, nylon 12T, nylon 6T/66, nylon 10T/1012, nylon 61/66, nylon 6T/61/66, or a combination thereof.

4. The nylon-based alloy resin composition of claim 1, wherein the styrene-based thermoplastic resin is polystyrene.

5. The nylon-based alloy resin composition of claim 1, wherein the styrene-based thermoplastic resin has a weight average molecular weight ranging from 10,000 to 5,000,000 g/mol.

6. The nylon-based alloy resin composition of claim 1, wherein the styrene-based thermoplastic resin has a melting point ranging from 200 to 320° C.

7. The nylon-based alloy resin composition of claim 1, wherein the modified nylon-based thermoplastic resin and the styrene-based thermoplastic resin are present in a weight ratio ranging from 0.3:1 to 7:1.

8. The nylon-based alloy resin composition of claim 1, wherein the inorganic filler comprises a fiber-type filler; a grain- or powder-type filler; or a combination thereof.

9. The nylon-based alloy resin composition of claim 8, wherein the fiber-type filler comprises a glass fiber, a carbon fiber, an alumina fiber, an aramid fiber, a carbonized silicon fiber, or a combination thereof.

10. The nylon-based alloy resin composition of claim 8, wherein the grain- or powder-type filler comprises talc, carbon black, titanium dioxide, barium carbonate, magnesium carbonate, or a combination thereof.

11. The nylon-based alloy resin composition of claim 8, wherein the inorganic filler comprises a mixture of 10 to 90 wt % of glass fiber and 10 to 90 wt % of titanium dioxide.

12. The nylon-based alloy resin composition of claim 8, wherein the inorganic filler comprises glass fiber having a cross-sectional aspect ratio ranging from 1.5 to 8.

13. The nylon-based alloy resin composition of claim 8, wherein the inorganic filler comprises titanium dioxide having a particle size ranging from 0.1 to 0.4 μm.

14. The nylon-based alloy resin composition of claim 1, wherein the inorganic filler has a moisture absorption rate of 0.05% or less.

15. The nylon-based alloy resin composition of claim 1, further comprising an antioxidant, a heat stabilizer, a light stabilizer, a fluid developing agent, a lubricant, a biocide, a release agent, a nucleating agent, a fluorescent whitening agent, or a combination thereof.

16. The nylon-based alloy resin composition of claim 1, having a viscosity ranging from 100 to 500 Pa·s at a shear rate ranging from 60 to 100 s⁻¹.

17. A light emitting diode (LED) reflector fabricated using the nylon-based alloy resin composition of claim 1.
